(19) United States
(12) Patent Application Publication
(10) Pub. No.: US 2026/0132791 A1
(43) Pub. Date: May 14, 2026

(54) PUMP

(71) Applicant: EBARA CORPORATION, Tokyo (JP)

(72) Inventors: Takaaki ARAI, Tokyo (JP); Masahito KAWAI, Tokyo (JP); Rinoko OKUMURA, Tokyo (JP)

(73) Assignee: EBARA CORPORATION, Tokyo (JP)

(21) Appl. No.: 19/380,056

(22) Filed: Nov. 5, 2025

(30) Foreign Application Priority Data
Nov. 13, 2024 (JP) 2024-198196

(51) Int. Cl. F04D 7/04; F04D 29/42

(52) U.S. Cl. CPC F04D 7/045; F04D 29/4293

(57) ABSTRACT

A pump casing capable of preventing clogging of a pump caused by foreign matter is disclosed. The pump includes: an impeller; and a pump casing that houses the impeller therein. The pump casing has a cutter that faces a leading edge of the impeller. The cutter has a front-side surface that forms a front side of the cutter in a rotation direction of the impeller. An angle formed between the front-side surface of the cutter and the leading edge of the impeller as viewed from a direction of a rotation axis of the impeller gradually decreases with rotation of the impeller. A maximum value of the angle is less than 90 degrees.

### CROSS REFERENCE TO RELATED APPLICATION

This document claims priority to Japanese Patent Application No. 2024-198196 filed Nov. 13, 2024, the entire contents of which are hereby incorporated by reference.

### BACKGROUND

A Pump (particularly a centrifugal pump) is used to deliver a liquid, such as sewage flowing through a sewer pipe.

Such sewage may contain foreign matters, such as fibrous substance or solid substance, which may adhere to and accumulate on impeller blades, causing clogging of the pump.

### SUMMARY

Therefore, there is provided a pump capable of preventing clogging of the pump caused by foreign matter.

Embodiments, which will be described below, relate to a pump for delivering a liquid.

In an embodiment, there is provided a pump comprising: an impeller; and a pump casing that houses the impeller therein, wherein the pump casing has a cutter that faces a leading edge of the impeller, the cutter has a front-side surface that forms a front side of the cutter in a rotation direction of the impeller, an angle formed between the front-side surface of the cutter and the leading edge of the impeller as viewed from a direction of a rotation axis of the impeller gradually decreases with rotation of the impeller, and a maximum value of the angle is less than 90 degrees.

In an embodiment, the front-side surface of the cutter has a curved shape when viewed from the direction of the rotation axis.

In an embodiment, the cutter has an upper surface facing the leading edge of the impeller, and an angle between the upper surface and the front-side surface of the cutter is an acute angle.

In an embodiment, the leading edge of the impeller has a front angular portion located in a front side of the leading edge in the rotation direction of the impeller, and the front angular portion has an acute cross-section.

In an embodiment, at least a portion of the front-side surface of the cutter has a serrated shape.

In an embodiment, the leading edge of the impeller has a front angular portion located in a front side of the leading edge in the rotation direction of the impeller, and at least a part of the front angular portion has a serrated shape.

In an embodiment, the pump casing has a groove formed in an inner surface thereof, and the groove is adjacent to the cutter.

In an embodiment, the leading edge of the impeller has a front angular portion located in a front side of the leading edge in the rotation direction of the impeller, the front angular portion of the impeller extends from a proximal end of the front angular portion coupled to a boss of the impeller to a distal end of the front angular portion while extending in a radially outward direction of the impeller, the front-side surface of the cutter extends from a proximal end of the front-side surface coupled to the pump casing to a distal end of the front-side surface while extending in a radially inward direction of the impeller, a distance in the radial direction of the impeller from the rotational axis of the impeller to the distal end of the front-side surface is less than or equal to a distance in the radial direction of the impeller from the rotational axis to the proximal end of the front angular portion, and a distance in the radial direction of the impeller from the rotational axis of the impeller to the proximal end of the front-side surface is larger than or equal to a distance in the radial direction of the impeller from the rotational axis to the distal end of the front angular portion.

In an embodiment, the pump casing has a suction port, and the cutter protrudes from the pump casing in a radially inward direction of the suction port.

In an embodiment, the pump casing further includes: a volute chamber having a shape surrounding the impeller; and a discharge port coupled to the volute chamber, wherein the cutter is located at an opposite side from the discharge port with respect to a center of the suction port.

The pump casing has the cutter that faces the leading edge of the impeller. As the impeller rotates, the angle between the front-side surface of the cutter and the leading edge of the impeller gradually decreases with the angle smaller than 90 degrees. Therefore, if foreign matter contained in the liquid is sucked into the pump casing, the foreign matter is sandwiched between the front-side surface of the cutter and the leading edge of the impeller and cut off. As a result, clogging of the pump with the foreign matter can be prevented.

### BRIEF DESCRIPTION OF THE DRAWINGS

FIG. 1 is a diagram showing an embodiment of a pump apparatus;

FIG. 2 is a view of an impeller, a pump casing, and a cutter as viewed from an axial direction;

FIG. 3 is a perspective view showing an embodiment of a casing liner and the cutter;

FIG. 4 is a view of the cutter and a leading edge as viewed from a direction of a rotation axis of the impeller;

FIG. 5 is a diagram explaining a change in positional relationship between the front-side surface of the cutter and the leading edge of the impeller with the rotation of the impeller;

FIGS. 6A to 6C are views each showing a cross-sectional shape of the cutter;

FIG. 7 is a perspective view of the cutter having a triangular cross section shown in FIG. 6C;

FIG. 8 is a view showing an embodiment of cross-sectional shapes of the cutter and the leading edge; and

FIG. 9 is a view showing other embodiments of the cutter and the leading edge.

### DESCRIPTION OF EMBODIMENTS

Embodiments will now be described with reference to the drawings.

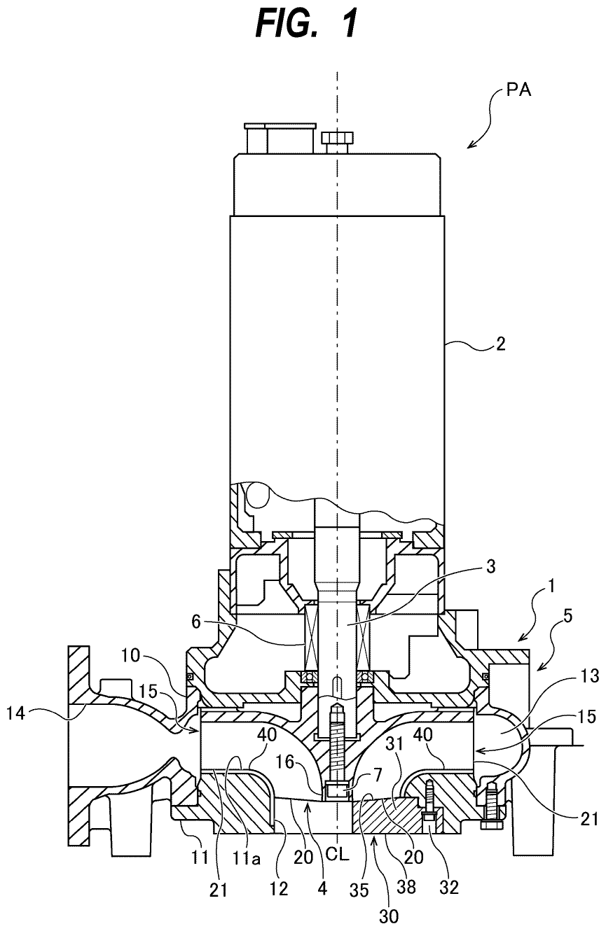

FIG. 1 shows an embodiment of a pump apparatus PA. As shown in FIG. 1, the pump apparatus PA includes a pump 1 configured to deliver liquid, and a motor 2 configured to drive the pump 1. In the embodiment shown in FIG. 1, the pump 1 is a volute pump for delivering liquid, such as sewage flowing through a sewer pipe.

The pump 1 includes a rotational shaft 3 coupled to the motor 2, an impeller 4 fixed to an end of the rotational shaft 3, and a pump casing 5 that houses the impeller 4 therein. The rotational shaft 3 is rotated by the motor 2, and the impeller 4 is rotated together with the rotational shaft 3 in the pump casing 5. A mechanical seal 6 is attached to the rotational shaft 3 and is located between the motor 2 and the impeller 4. The mechanical seal 6 is configured to prevent the liquid sucked in the pump 1 from entering the motor 2.

The pump casing 5 includes a casing body 10 arranged around the impeller 4, and a casing liner 11 coupled to the casing body 10. The casing body 10 has a volute chamber 13 formed therein and a discharge port 14 coupled to the volute chamber 13. The volute chamber 13 has a shape that surrounds the impeller 4. The casing liner 11 has a suction port 12 formed in the center of the casing liner 11.

The impeller 4 is fixed to the end of the rotational shaft 3 by a fixing device 7. When the impeller 4 is rotated by the motor 2, the liquid is sucked in through the suction port 12. The rotation of the impeller 4 imparts a velocity energy to the liquid. As the liquid flows through the volute chamber 13, the velocity energy is converted into pressure, so that the liquid is pressurized. The pressurized liquid is discharged through the discharge port 14. The blades 15 of the impeller 4 face an inner surface 11a of the casing liner 11, with a gap of a predetermined magnitude formed between the blades 15 and the inner surface 11a.

FIG. 2 is a view of the impeller 4, the pump casing 5, and a cutter 30 (described later) as viewed from an axial direction. As shown in FIG. 2, the impeller 4 has the plurality of blades 15 (two blades in this embodiment) and a boss 16 to which the blades 15 are fixed. The blades 15 rotate together with the rotational shaft 3 around the boss 16 (see solid arrows in FIG. 2).

As shown in FIG. 2, the pump casing 5 has a tongue portion 25 that forms a beginning of a spiral of the volute chamber 13. The volute chamber 13 extends in a circumferential direction of the impeller 4, and the liquid flowing in the volute chamber 13 is divided by the tongue portion 25. Therefore, most of the liquid flows toward the discharge port 14, while a part of the liquid circulates through the volute chamber 13 (see dotted arrows in FIG. 2).

In the embodiment shown in FIG. 2, each blade 15 is a backswept blade. More specifically, each blade 15 has a leading edge 20 extending spirally from the boss 16 and a trailing edge 21 extending spirally from the leading edge 20. The leading edge 20 and the trailing edge 21 are coupled to each other and are integrally formed.

The leading edge 20 is located radially inwardly of the suction port 12. The trailing edge 21 faces the inner surface 11a of the casing liner 11 (see FIG. 1). Therefore, when the casing liner 11 is viewed from the direction of the axis CL of the rotational shaft 3 (i.e., the direction of the rotational axis CL of the impeller 4), the leading edge 20 is exposed from the casing liner 11, and the trailing edge 21 is located at the back side of the casing liner 11.

As described above, the liquid to be pumped by the pump apparatus PA may contain foreign matter, such as fibrous substance or solid substance. The leading edge 20 of the blade 15 is located radially inwardly of the suction port 12. Therefore, when the liquid is sucked into the suction port 12 by the rotation of the impeller 4, the foreign matter may adhere to and accumulate on the leading edge 20. When the impeller 4 rotates in this state, the foreign matter may be trapped in the gap between the trailing edge 21 and the inner surface 11a of the casing liner 11, resulting in clogging of the pump 1. Therefore, in order to prevent the pump 1 from being clogged by the foreign matter, the pump 1 (more specifically, the pump casing 5) has the cutter 30 configured to cut off the foreign matter.

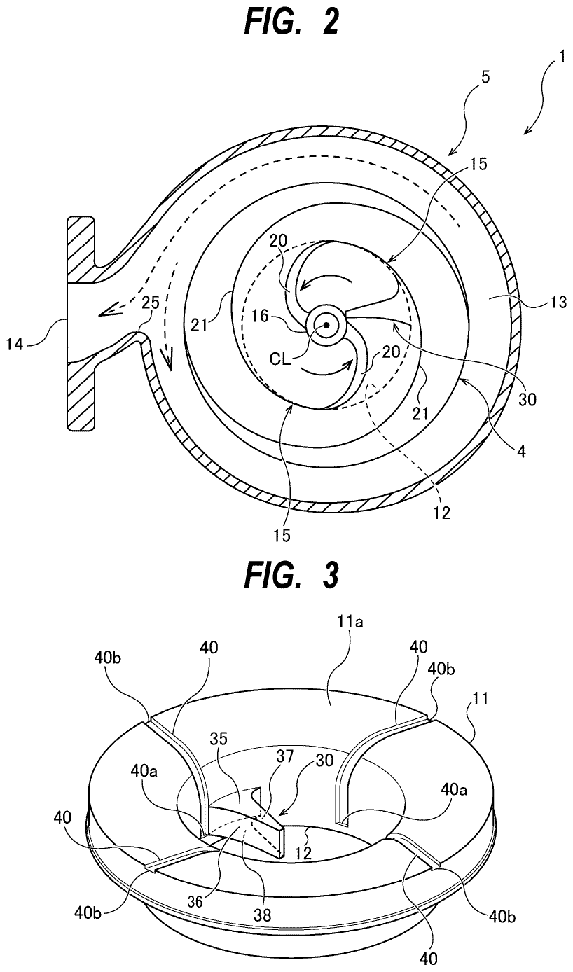

FIG. 3 is a perspective view showing an embodiment of the casing liner 11 and the cutter 30. The cutter 30 is fixed to the casing liner 11 of the pump casing 5. More specifically, the cutter 30 is fixed to the inner surface 11a of the casing liner 11, which forms the suction port 12. The cutter 30 protrudes from the casing liner 11 in the radially inward direction of the suction port 12 so as to obstruct flow path for the liquid passing through the suction port 12. In this embodiment, the cutter 30 is made of a different material from the casing liner 11. In one embodiment, the cutter 30 is made of a metal having high hardness, such as cast iron, stainless steel, iron, or gunmetal. The cutter 30 is fixed to a cutter mounting portion (not shown) provided on the casing liner 11 by a fixing device (not shown). This configuration allows an operating person to easily replace the cutter 30 with new one when the cutter 30 has worn out. In one embodiment, the cutter 30 may be a member integrally formed with the casing liner 11.

The cutter 30 has an upper surface 35 that faces the leading edges 20 of the blades 15 when the impeller 4 is housed in the pump casing 5, a front-side surface 36 that forms a front side of the cutter 30 in the rotating direction of the impeller 4 (see the arrow in FIG. 2) , a back-side surface 37 that forms a back side of the cutter 30 in the rotating direction of the impeller 4, and a lower surface 38 located opposite the upper surface 35. A gap of a predetermined magnitude is formed between each leading edge 20 of the impeller 4 housed in the pump casing 5 and the upper surface 35 of the cutter 30. The magnitude of this gap is small enough to prevent the foreign matter from entering the gap so as to avoid the clogging of the pump 1. In one embodiment, the gap between each leading edge 20 of the impeller 4 and the upper surface 35 of the cutter 30 is less than 1 mm.

As shown in FIG. 3, the casing liner 11 of the pump casing 5 has grooves 40 formed in the inner surface 11a of the casing liner 11. In this embodiment, the casing liner 11 has a plurality of (four) grooves 40 arranged along the circumferential direction of the suction port 12. One of the plurality of grooves 40 is arranged upstream of the cutter 30 in the rotating direction of the impeller 4 and is adjacent to the cutter 30. More specifically, the plurality of grooves 40 are formed in the inner surface 11a of the casing liner 11 and extend from the suction port 12 to the volute chamber 13. The front-side surface 36 of the cutter 30 is coupled to a starting part 40a of the groove 40, and an ending part 40b of the groove 40 is coupled to the volute chamber 13.

In one embodiment, the casing liner 11 may have one groove 40 adjacent to the cutter 30. In another embodiment, the casing liner 11 may have no groove 40.

When the impeller 4 is rotated by the motor 2, the foreign matter contained in the liquid is sandwiched between the front-side surface 36 of the cutter 30 arranged in the suction port 12 and the leading edge 20 of the impeller 4, so that the foreign matter is cut off. More specifically, as the impeller 4 rotates, the foreign matter is sandwiched between the front-side surface 36 of the cutter 30 and the leading edge 20 of the impeller 4 and cut off along the radial direction of the impeller 4. As the impeller 4 rotates, the cut foreign matter is guided into the groove 40 formed in the casing liner 11, moves along the groove 40, and is released into the volute chamber 13 at the ending part 40b of the groove 40. The foreign matter is then discharged to the outside through the discharge port 14.

As shown in FIG. 2, the cutter 30 is disposed at the opposite side from the discharge port 14 with respect to the center of the suction port 12. The center of the suction port 12 coincides with the axis CL of the rotational shaft 3 (i.e., the rotational axis CL of the impeller 4). The tongue portion 25 is located adjacent to the discharge port 14. With this arrangement, the foreign matter is released into the volute chamber 13 at a position opposite the tongue portion 25. Thereafter, the foreign matter is subjected to the centrifugal force and moves in the volute chamber 13 by the flowing liquid. Therefore, the foreign matter is not caught by the tongue portion 25 and is discharged to the outside through the discharge port 14.

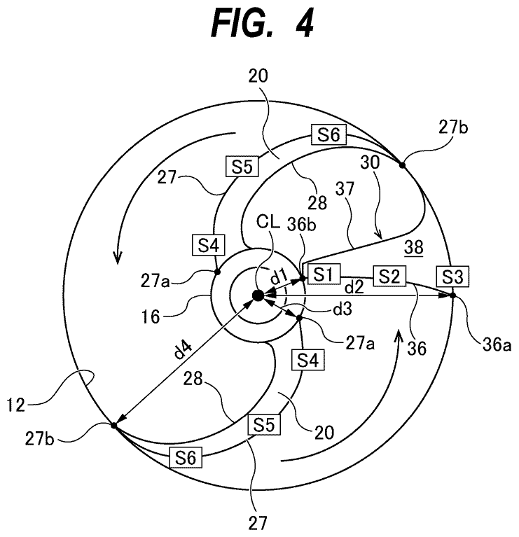

FIG. 4 is a view of the cutter 30 and the leading edge 20 as viewed from the direction of the rotation axis CL of the impeller 4. As shown in FIG. 4, the leading edge 20 has a front angular portion 27 that forms a front side of the leading edge 20 in the rotating direction of the impeller 4 indicated by the arrow in FIG. 4, and a back angular portion 28 that forms a back side of the leading edge 20 in the rotating direction of the impeller 4. The front angular portion 27 extends from a proximal end 27a of the front angular portion 27 coupled to the boss 16 to a distal end 27b of the front angular portion 27 while curving in the radially outward direction of the impeller 4. The front-side surface 36 of the cutter 30 extends from a proximal end 36a of the front-side surface 36 coupled to the casing liner 11 to a distal end 36b of the front-side surface 36 while curving in the radially inward direction of the impeller 4.

A distance d1 in the radial direction of the impeller 4 from the rotation axis CL of the impeller 4 to the distal end 36b of the front-side surface 36 is less than or equal to a distance d3 in the radial direction of the impeller 4 from the rotation axis CL of the impeller 4 to the proximal end 27a of the front angular portion 27. In this embodiment, the distance d1 is the same as the distance d3, and the distances d1 and d3 are equal to the radius of the boss 16. Furthermore, a distance d2 in the radial direction of the impeller 4 from the rotation axis CL of the impeller 4 to the proximal end 36a of the front-side surface 36 is larger than or equal to a distance d4 in the radial direction of the impeller 4 from the rotation axis CL of the impeller 4 to the distal end 27b of the front angular portion 27. In this embodiment, the distance d2 is the same as the distance d4, and the distances d2 and d4 are equal to the radius of the suction port 12. With this configuration, the cutter 30 can cut off the foreign matter sucked in the suction port 12 with the rotation of the impeller 4 regardless of the position of the foreign matter on the leading edge 20.

A positional relationship between the cutter 30 and the leading edge 20 changes as the impeller 4 rotates. First, a distal region S1 of the cutter 30, where the distal end 36b of the cutter 30 is located, faces a proximal region S4 of the leading edge 20, where the proximal end 27a of the leading edge 20 is located. Next, a central region S2 of the cutter 30 faces a central region S5 of the leading edge 20. Then, a proximal region S3 of the cutter 30, where the proximal end 36a of the cutter 30 is located, faces a distal region S6 of the leading edge 20, where the distal end 27b of the leading edge 20 is located. The central region S2 of the cutter 30 is located between the distal region S1 and the proximal region S3. The central region S5 of the leading edge 20 is located between the proximal region S4 and the distal region S6.

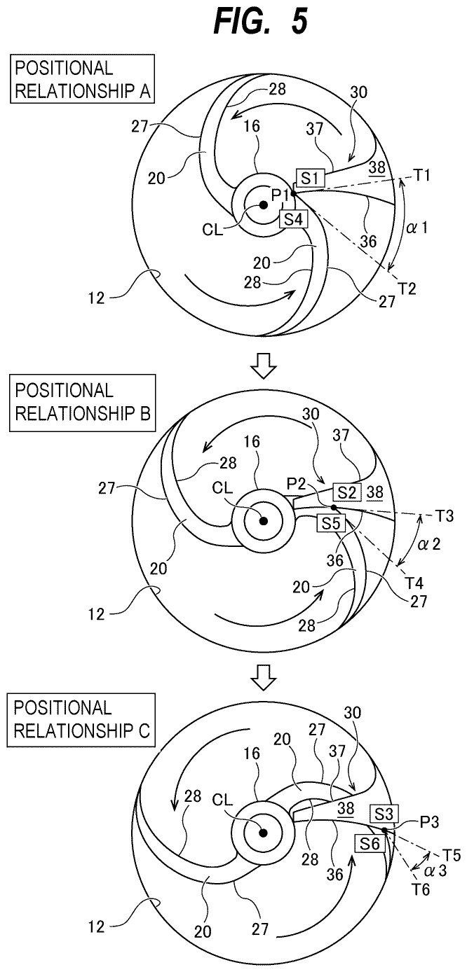

FIG. 5 is a diagram illustrating the change in positional relationship between the front-side surface 36 of the cutter 30 and the leading edge 20 of the impeller 4 with the rotation of the impeller 4. A positional relationship A in FIG. 5 illustrates the positional relationship in which the distal region S1 of the cutter 30 faces the proximal region S4 of the leading edge 20. A positional relationship B in FIG. 5 illustrates the positional relationship in which the central region S2 of the cutter 30 faces the central region S5 of the leading edge 20. A positional relationship C in FIG. 5 illustrates the positional relationship in which the proximal region S3 of the cutter 30 faces the distal region S6 of the leading edge 20.

The positional relationship between the cutter 30 and the leading edge 20 changes from the positional relationship A to the positional relationship C via the positional relationship B as the impeller 4 rotates. Therefore, when viewed from the direction of the rotation axis CL of the impeller 4, the angle formed between the front-side surface 36 of the cutter 30 and the leading edge 20 (more specifically, the front angular portion 27) of the impeller 4 includes angle α1 in the positional relationship A, angle α2 in the positional relationship B, and angle α3 the in positional relationship C.

The angle between the front-side surface 36 and the leading edge 20 (more specifically, the front angular portion 27) is an angle between a tangent to the front-side surface 36 and a tangent to the leading edge 20 (more specifically, the front angular portion 27) at an intersection of the front-side surface 36 and the leading edge 20 (more specifically, the front angular portion 27) as viewed from the direction of the rotation axis CL of the impeller 4.

Specifically, the angle α1 in the positional relationship A is an angle between a tangent T1 to the front-side surface 36 and a tangent T2 to the front angular portion 27 at an intersection P1 of the distal region S1 of the front-side surface 36 and the proximal region S4 of the leading edge 20 (more specifically, the front angular portion 27) as viewed from the direction of the rotation axis CL of the impeller 4.

The angle α2 in the positional relationship B is an angle between a tangent T3 to the front-side surface 36 and a tangent T4 to the front angular portion 27 at an intersection P2 of the central region S2 of the front-side surface 36 and the central region S5 of the leading edge 20 (more specifically, the front angular portion 27) as viewed from the direction of the rotational axis CL of the impeller 4. The angle α3 in the positional relationship C is an angle between a tangent T5 to the front-side surface 36 and a tangent T6 to the front angular portion 27 at an intersection P3 of the proximal region S3 of the front-side surface 36 and the distal region S6 of the leading edge 20 (more specifically, the front angular portion 27) as viewed from the direction of the rotational axis CL of the impeller 4.

When viewed from the direction of the rotation axis CL of the impeller 4, the front-side surface 36 of the cutter 30 has a curved shape such that the angle between the front-side surface 36 and the leading edge 20 gradually decreases as the impeller 4 rotates. More specifically, the front-side surface 36 has a curved shape that is concave toward the back-side surface 37 at the central region S2. In one embodiment, when viewed from the direction of the rotation axis CL of the impeller 4, the front-side surface 36 of the cutter 30 may have a partially linear shape. For example, when viewed from the direction of the rotation axis CL of the impeller 4, the front-side surface 36 may have a linear shape from the distal region S1 to the central region S2 and may have a curved shape from the central region S2 to the proximal region S3. A maximum value of the angle between the front-side surface 36 and the leading edge 20 is less than 90 degrees. Specifically, the angle between the front-side surface 36 and the leading edge 20 gradually decreases within an angle range larger than 0 degrees and less than 90 degrees as the impeller 4 rotates.

In this embodiment, the front angular portion 27 of the impeller 4 has a curved shape in the central region S5 that bulges out toward the opposite side from the back angular portion 28 when viewed from the direction of the rotation axis CL of the impeller 4. The shape of the front-side surface 36 of the cutter 30 is appropriately determined in accordance with the shape of the front angular portion 27 of the impeller 4 such that the angle between the front-side surface 36 and the leading edge 20 when viewed from the direction of the rotation axis CL of the impeller 4 gradually decreases as the impeller 4 rotates.

In this embodiment, as an example, the angle α1 is 50 degrees, the angle α2 is 30 degrees, and the angle α3 is 25 degrees. Between the positional relationship A and the positional relationship B, the angle between the front-side surface 36 and the leading edge 20 gradually decreases from the angle α1 to the angle α2 as the impeller 4 rotates. Between the positional relationship B and the positional relationship C, the angle between the front-side surface 36 and the leading edge 20 gradually decreases from the angle α2 to the angle α3 as the impeller 4 rotates.

In this specification, “the gradual decrease in the angle between the front-side surface 36 and the leading edge 20 with the rotation of the impeller 4” may include a temporary increase in the angle between the front-side surface 36 and the leading edge 20 with the rotation of the impeller 4 that may occur within a tolerance or error range under manufacturing conditions, etc. Furthermore, in this specification, “the maximum value of the angle between the front-side surface 36 and the leading edge 20 that is smaller than 90 degrees” may include an angle greater than 90 degrees that may occur within a tolerance or error range under manufacturing conditions, etc.

If the angle between the front-side surface 36 and the leading edge 20 increases with the rotation of the impeller 4, the foreign matter may move outward, and the effect of sandwiching the foreign matter between the front-side surface 36 and the leading edge 20 may not be sufficient. In particular, if the foreign matter is a long fibrous substance or a hard solid substance and if the angle between the front-side surface 36 and the leading edge 20 increases with the rotation of the impeller 4, the foreign matter may not be completely cut off, causing the pump 1 to become clogged. According to this embodiment, the angle between the front-side surface 36 and the leading edge 20 gradually decreases with the rotation of the impeller 4, allowing the cutter 30 to cut off the foreign matter while maintaining the action of sandwiching the foreign matter between the front-side surface 36 and the leading edge 20. As a result, clogging of the pump 1 with the foreign matter can be prevented.

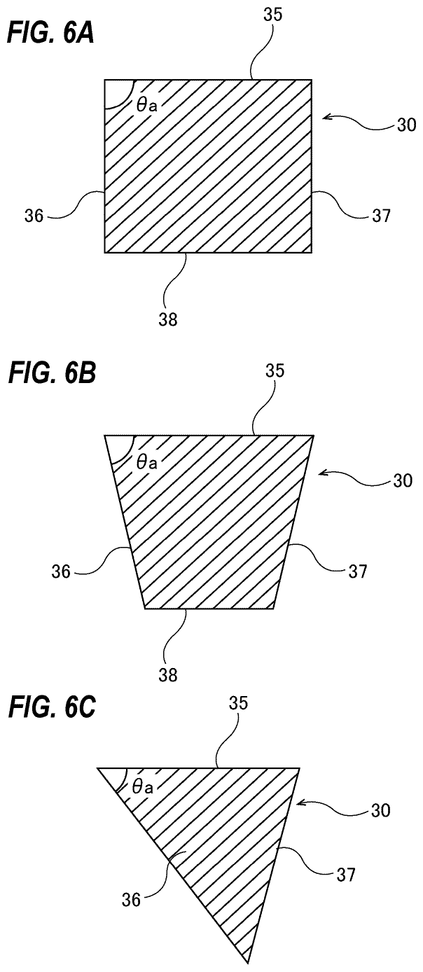

FIGS. 6A to 6C are diagrams showing the cross-sectional shape of the cutter 30. In this embodiment, as shown in FIG. 6A, the front-side surface 36 and the back-side surface 37 are coupled to the upper surface 35 and the lower surface 38, and the cross-sectional shape of the cutter 30 is rectangular. In this embodiment, an angle θa formed between the upper surface 35 and the front-side surface 36 is a right angle (90 degrees).

In another embodiment, as shown in FIG. 6B, the angle θa between the upper surface 35 and the front-side surface 36 may be an acute angle. In the embodiment shown in FIG. 6B, the cross-sectional shape of the cutter 30 is trapezoidal. In yet another embodiment, as shown in FIG. 6C, the cutter 30 does not have the lower surface 38, and the vertical cross-sectional shape of the cutter 30 may be triangular. In the embodiment shown in FIG. 6C, the angle θa between the upper surface 35 and the front-side surface 36 is an acute angle. Although not shown, the angle θa may be an obtuse angle as long as the cutter 30 can cut the foreign matter.

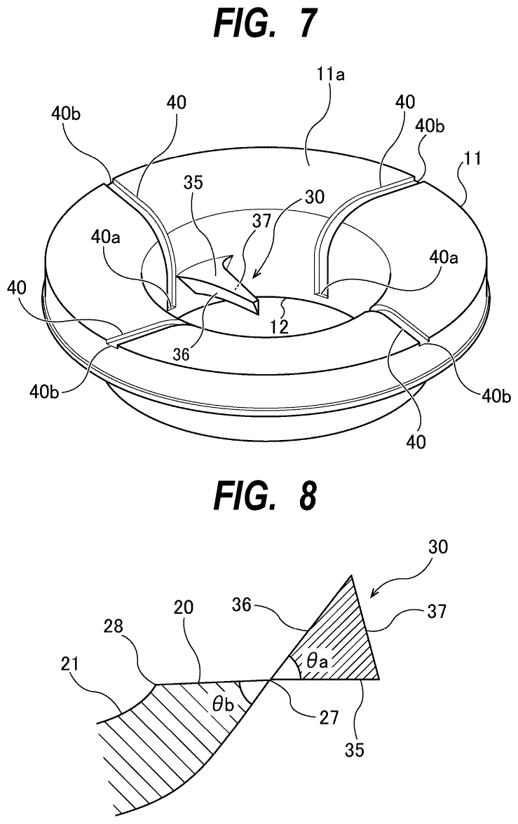

FIG. 7 is a perspective view of the cutter 30 having the triangular cross section shown in FIG. 6C. The cutter 30 having the acute angle θa formed between the upper surface 35 and the front-side surface 36 can effectively cut off the foreign matter existing between the front-side surface 36 and the leading edge 20.

FIG. 8 is a diagram showing an embodiment of the cross-sectional shapes of the cutter 30 and the leading edge 20. The cutter 30 of this embodiment is the cutter 30 shown in FIG. 7. As shown in FIG. 8, an angle θb of the cross section of the front angular portion 27 of the leading edge 20 of the impeller 4 may be an acute angle. When the foreign matter is sandwiched between the cutter 30 having the cross-sectional shape with the acute angle θa and the leading edge 20 having the cross-sectional shape with the acute angle θb, the cutter 30 can effectively cut off the foreign matter.

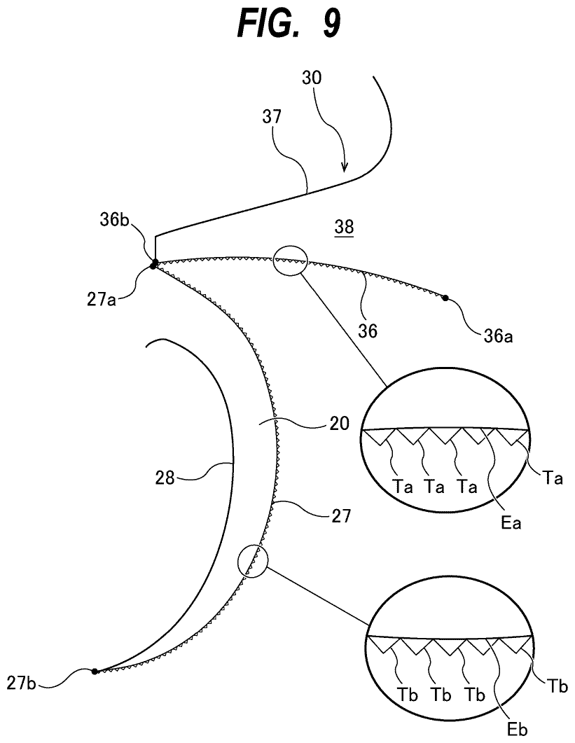

FIG. 9 is a diagram showing another embodiment of the cutter 30 and the leading edge 20. The cutter 30 of this embodiment has a serrated shape in at least a portion of the front-side surface 36. As shown in FIG. 9, the front-side surface 36 may have a serrated shape over the entire length from the proximal end 36a to the distal end 36b, or may have a serrated shape over a part of the length from the proximal end 36a to the distal end 36b. As shown enlarged in FIG. 9, the serrated front-side surface 36 has a plurality of continuously arranged serrated teeth Ta and an edge portion Ea which is the edge of the front-side surface 36 on which the plurality of serrated teeth Ta are formed. In this embodiment, each of the serrated teeth Ta has a triangular shape, while, in one embodiment, each of the serrated teeth Ta may have a rectangular shape or another shape (for example, a portion of each serrated tooth Ta has a curved shape).

The leading edge 20 of this embodiment has a serrated shape in at least a part of the front angular portion 27. As shown in FIG. 9, the front angular portion 27 may have a serrated shape over the entire length from the proximal end 27a to the distal end 27b, or may have a serrated shape over a part of the length from the proximal end 27a to the distal end 27b. As shown in enlarged diagram of FIG. 9, the serrated front angular portion 27 has a plurality of continuously arranged serrated teeth Tb and an edge portion Eb that is the edge of the front angular portion 27 on which the plurality of serrated teeth Tb are formed. In this embodiment, each of the serrated teeth Tb has a triangular shape, while, in one embodiment, each of the serrated teeth Ta may have a rectangular shape or another shape (for example, a portion of each serrated tooth Tb has a curved shape).

In this specification, an angle formed by the front-side surface 36 having the serrated teeth Ta and the front angular portion 27 having the serrated teeth Tb is defined by an angle formed by the edge portion Ea of the front-side surface 36 and the edge portion Eb of the front angular portion 27. In a shape including the contour of the serrated teeth Ta of the front-side surface 36 and the contour of the serrated teeth Tb of the front angular portion 27, the angle formed by the front-side surface 36 and the leading edge 20 can temporarily increase as the impeller 4 rotates. The edge portion Ea of the front-side surface 36 of the cutter 30 has a curved shape such that the angle between the edge portion Ea of the front-side surface 36 and the edge portion Eb of the leading edge 20 gradually decreases as the impeller 4 rotates.

In one embodiment, the front-side surface 36 may have the serrated shape and the front angular portion 27 may not have the serrated shape. In another embodiment, the front angular portion 27 may have the serrated shape and the front-side surface 36 may not have the serrated shape.

According to the embodiment, the front-side surface 36 having the serrated teeth Ta and the leading edge 20 having the serrated teeth Tb can bite the foreign matter between the front-side surface 36 and the leading edge 20, thereby effectively cutting off the foreign matter.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

What is claimed is:

1. A pump comprising:
an impeller; and
a pump casing that houses the impeller therein,
wherein the pump casing has a cutter that faces a leading edge of the impeller,
the cutter has a front-side surface that forms a front side of the cutter in a rotation direction of the impeller,
an angle formed between the front-side surface of the cutter and the leading edge of the impeller as viewed from a direction of a rotation axis of the impeller gradually decreases with rotation of the impeller, and
a maximum value of the angle is less than 90 degrees.

2. The pump according to claim 1, wherein the front-side surface of the cutter has a curved shape when viewed from the direction of the rotation axis.

3. The pump according to claim 1, wherein the cutter has an upper surface facing the leading edge of the impeller, and an angle between the upper surface and the front-side surface of the cutter is an acute angle.

4. The pump according to claim 1, wherein the leading edge of the impeller has a front angular portion located in a front side of the leading edge in the rotation direction of the impeller, and the front angular portion has an acute cross-section.

5. The pump according to claim 1, wherein at least a portion of the front-side surface of the cutter has a serrated shape.

6. The pump according to claim 1, wherein the leading edge of the impeller has a front angular portion located in a front side of the leading edge in the rotation direction of the impeller, and at least a part of the front angular portion has a serrated shape.

7. The pump according to claim 1, wherein the pump casing has a groove formed in an inner surface thereof, and the groove is adjacent to the cutter.

8. The pump according to claim 1, wherein the leading edge of the impeller has a front angular portion located in a front side of the leading edge in the rotation direction of the impeller,
the front angular portion of the impeller extends from a proximal end of the front angular portion coupled to a boss of the impeller to a distal end of the front angular portion while extending in a radially outward direction of the impeller,
the front-side surface of the cutter extends from a proximal end of the front-side surface coupled to the pump casing to a distal end of the front-side surface while extending in a radially inward direction of the impeller,
a distance in the radial direction of the impeller from the rotational axis of the impeller to the distal end of the front-side surface is less than or equal to a distance in the radial direction of the impeller from the rotational axis to the proximal end of the front angular portion, and
a distance in the radial direction of the impeller from the rotational axis of the impeller to the proximal end of the front-side surface is larger than or equal to a distance in the radial direction of the impeller from the rotational axis to the distal end of the front angular portion.

9. The pump according to claim 1, wherein the pump casing has a suction port, and the cutter protrudes from the pump casing in a radially inward direction of the suction port.

10. The pump according to claim 9, wherein the pump casing further includes:
a volute chamber having a shape surrounding the impeller; and
a discharge port coupled to the volute chamber,
wherein the cutter is located at an opposite side from the discharge port with respect to a center of the suction port.
